(19) United States
(12) Patent Application Publication
(10) Pub. No.: US 2008/0206631 A1
(43) Pub. Date: Aug. 28, 2008

(54) ELECTROLYTES, ELECTRODE COMPOSITIONS AND ELECTROCHEMICAL CELLS MADE THEREFROM

(75) Inventors: Leif Christensen, St. Paul, MN (US); Mark N. Obrovac, St. Paul, MN (US); Phat T. Pham, Little Canada, MN (US); William M. Lamanna, Stillwater, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/776,812

(22) Filed: Jul. 12, 2007

Related U.S. Application Data
(63) Continuation-in-part of application No. 11/679,591, filed on Feb. 27, 2007.

(51) Int. Cl. H01M 6/16

(52) U.S. Cl. 429/149; 429/188

(57) ABSTRACT

Electrochemical cells are disclosed that include electrodes comprising a composite that includes an active material, graphite and a binder. The amount of graphite in the composite is greater than about 20 volume percent of the total volume of the active material and graphite in the composite. The porosity of the composite is less than about 20%. The cells also comprise an electrolyte that includes a vinylene carbonate derivative or a halogenated ethylene carbonate derivative.

### RELATED APPLICATION

This application is a continuation-in-part, and claims priority to U.S. Ser. No. 11/679,591, which was filed on Feb. 27, 2007, and is herein incorporated by reference in its entirety.

### FIELD

This invention relates to novel electrolyte formulations and electrode compositions for use in electrochemical cells.

### BACKGROUND

Rechargeable lithium ion batteries are included in a variety of electronic devices. Most commercially available lithium ion batteries have negative electrodes that contain materials such as graphite that are capable of incorporating lithium through an intercalation mechanism during charging. Such intercalation-type electrodes generally exhibit good cycle life and coulombic efficiency. However, the amount of lithium that can be incorporated per unit mass of intercalation-type material is relatively low.

A second class of negative electrode materials is known that incorporate lithium through an alloying mechanism during charging. Although these alloy-type materials can often incorporate higher amounts of lithium per unit mass than intercalation-type materials, the addition of lithium to the alloy is usually accompanied with a large volume change. Some alloy-type negative electrodes exhibit relatively poor cycle life and low energy density. The poor performance of these alloy-type electrodes can result from the large volume changes in the electrode compositions when they are lithiated and then delithiated. The large volume change accompanying the incorporation of lithium can result in the deterioration of electrical contact between the alloy, conductive diluent (e.g., carbon powder), binder, and current collector that typically form the anode. The deterioration of electrical contact, in turn, can result in diminished capacity over the cycle life of the electrode. Electrode composites made with alloy-type materials typically can have high porosities, frequently above 50% of the volume of the composite—especially when lithiated. This results in reduction of the energy density of electrochemical cells made with these electrodes containing these types of materials.

### SUMMARY

In view of the foregoing, it is recognized that there is a need for negative electrodes that have increased cycle life and high energy density.

In one aspect, provided is a composite that comprises an active material, graphite, and a binder. The amount of graphite is greater than about 20 volume percent of the total volume of the active material and the graphite, and the porosity of the composite is less than about 20%.

In a second aspect, provided is an electrode comprising a composite that includes an active material, graphite, and a binder. The amount of graphite in the unlithiated composite is greater than about 20 volume percent of the total volume of the active material and the graphite. The composite is lithiated and the porosity of the composite is less than about 30%.

In another aspect, provided is a method of making an electrode including the steps of mixing an active material, binder, and graphite to form a composite, and compressing the composite to form a compressed composite. The amount of graphite in the composite is greater than about 20 volume percent of the total volume of the active material and the graphite and the porosity of the compressed composite is less than about 20%.

In another additional aspect, provided is an electrochemical cell comprising an electrode that includes a composite comprising an active material, graphite, and a binder, wherein the amount of graphite is greater than about 20 volume percent of the total volume of the active material and the graphite, and

wherein the porosity of the composite is less than about 20%; and an electrolyte comprising at least one of
a) a vinylene carbonate having the structure

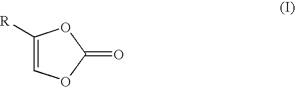

b) an ethylene carbonate having the structure

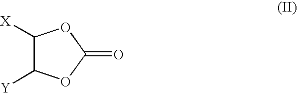

wherein R is H or an alkyl or alkenyl group containing one to four carbon atoms; X is H, F, or Cl and Y is F or Cl or an alkyl or alkenyl group containing one to four carbon atoms.

In yet another aspect, provided is an electrochemical cell comprising an electrode that includes a composite comprising an active material, graphite, and a binder, wherein the amount of graphite in the unlithiated composite is greater than about 20 volume percent of the total volume of the active material and the graphite in the composite, wherein the composite is lithiated, and wherein the porosity of the composite is less than about 30%; and an electrolyte comprising at least one of
a) a vinylene carbonate having the structure

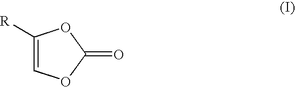

or
b) an ethylene carbonate having the structure

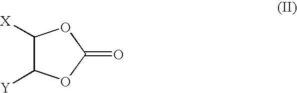

wherein R is H or an alkyl or alkenyl group containing one to four carbon atoms; X is H, F, or Cl; and Y is F or Cl or an alkyl or alkenyl group containing one to four carbon atoms.

The electrolytes and electrodes of this disclosure can be used to make electrochemical cells that have improved cycle life and high specific capacity. They also can improve the energy density and safety of lithium ion batteries with from these components.

In this disclosure:

the articles “a”, “an”, and “the” are used interchangeably with “at least one” to mean one or more of the elements being described;

the term “metal” refers to both metals and to metalloids such as carbon, silicon and germanium, whether in an elemental or ionic state;

the term “alloy” refers to a composition of two or more metals that have physical properties different than those of any of the metals by themselves;

the terms “lithiate” and “lithiation” refer to a process for adding lithium to an electrode material;

the term “lithiated”, when it refers to a negative electrode, means that the electrode has incorporated lithium ions in an amount greater than 50% of its total capacity to absorb lithium.

the terms “delithiate” and “delithiation” refer to a process for removing lithium from an electrode material;

the term “active material” refers to a material that can undergo initiation and delithiation, but in this application the term “active material” does not include graphite. It is understood, however, that the active material may comprise a carbon-containing alloy that is made from graphite;

the terms “charge” and “charging” refer to a process for providing electrochemical energy to a cell;

the terms “discharge” and “discharging” refer to a process for removing electrochemical energy from a cell, e.g., when using the cell to perform desired work;

the phrase “positive electrode” refers to an electrode (often called a cathode) where electrochemical reduction and lithiation occurs during a discharging process; and

the phrase “negative electrode” refers to an electrode (often called an anode) where electrochemical oxidation and delithiation occurs during a discharging process; and

the terms “powders” or “powdered materials” refer to particles that can have an average maximum length in one dimension that is no greater than about 100 μm.

Unless the context clearly requires otherwise, the terms “aliphatic”, “cycloaliphatic” and “aromatic” include substituted and imsubstituted moieties containing only carbon and hydrogen, moieties that contain carbon, hydrogen and other atoms (e.g., nitrogen or oxygen ring atoms), and moieties that are substituted with atoms or groups that can contain carbon, hydrogen or other atoms (e.g., halogen atoms, alkyl groups, ester groups, ether groups, amide groups, hydroxyl groups or amine groups).

### DETAILED DESCRIPTION

All numbers are herein assumed to be modified by the term “about”. The recitation of numerical ranges by endpoints includes all numbers subsumed within that range (e.g., 1 to 5 includes 1, 1.5, 2, 2.75, 3, 3.80, 4, and 5).

Composites and electrodes made with those composites according to the present invention can be used as negative electrodes. The composites of this invention include active materials, graphite and a binder.

A variety of active materials can be employed to make the electrode composite. These active materials can be in the form of a powder. The active materials can be in the form of a single chemical element or as an alloy. Exemplary active materials can for example include one or more metals such as carbon, silicon, silver, lithium, tin, bismuth, lead, antimony, germanium, zinc, gold, platinum, palladium, arsenic, aluminum, gallium, and indium. The active materials can further include one or more inactive elements such as, molybdenum, niobium, tungsten, tantalum, iron, copper, titanium, vanadium, chromium, manganese, nickel, cobalt, zirconium, yttrium, lanthanides, actinides and alkaline earth metals. Alloys can be amorphous, can be crystalline or nanocrystalline, or can exist in more than one phase. Powders can have a maximum length in one dimension that is no greater than 100 μm, no greater than 80 μm, no greater than 60 μm, no greater than 40 μm, no greater than 20 μm, no greater than 2 μm, or even smaller. The powdered materials can, for example, have a particle diameter (smallest dimension) that is submicron, at least 0.5 μm, at least 1 μm, at least 2 μm, at least 5 μm, or at least 10 μm or even larger. For example, suitable powders often have dimensions of 0.5 μm to 100 μm. 0.5 μm to 80 μm, 0.5 μto 60 μm, 0.5 μm to 40 μm, 0.5 μm to 2.0 μm, 10 to 60 μm to 60 μm, 40 to 60 μm, 2 to 40 μm, 10 to 40 μm, 5 to 20 μm, or 10 to 20 μm. The powdered materials can contain optional matrix formers. Each phase originally present in the particle (i.e., before a first lithiation) can be in contact with other phases in the particle. For example, in particles based on a silicon:copper:silver alloy, a silicon phase can be in contact with both a copper silicide phase and a silver or silver alloy phase. Each phase in a particle can for example have a grain size less than 50 nm, less than 40 nm, less than 30 nm, less than 20 nm, less than 15 nm, or even smaller.

Exemplary silicon-containing active materials include the silicon alloys wherein the active material comprises from about 50 to about 85 mole percent silicon, from about 5 to about 12 mole percent iron, from about 5 mole percent to about 12 mole percent titanium, and from about 5 to about 12 mole percent carbon. Additionally, the active material can be pure silicon. More examples of useful silicon alloys include compositions that include silicon, copper, and silver or silver alloy such as those discussed in U.S. Pat. Appl. Publ. No. 2006/0046144 A1 (Obrovac et al); multiphase, silicon-containing electrodes such as those discussed in U.S. Pat. Appl. Publ. No. 2005/0031957 A1 (Christensen et al); silicon alloys that contain tin, indium and a lanthanide, actinide element or yttrium such as those described in U.S. Ser. Nos. 11/387,205, 11/387,219, and 11/387,557 (all to Obrovac et al.) filed Mar. 23, 2006; amorphous alloys having a high silicon content such as those discussed in U.S. Ser. No. 11/562,227 (Christensen et al), filed Nov. 21, 2006; other powdered materials used for electrodes such as those discussed in U.S. Ser. No. 11/419,564 (Krause et al.) filed Jan. 22, 2006; U.S. Ser. No. 11/469,561 (Le) filed Sep. 1, 2006; PCT US2006/038558 (Krause et al.) filed Oct. 2, 2006; and U.S. Pat. No. 6,203,944 (Turner);

Useful active materials for making positive electrodes of the electrochemical cells and batteries or battery packs of this invention include lithium. Examples of positive active materials include Li_{4/3}Ti_{5/3}O₄, LiV₃O₈, LiV₂O₅, LiCo_{0.2}Ni_{0.8}O₂, LiNi_{0.33}Mn_{0.33}Co_{0.33}, Lini_{0.5}Mn_{0.2}, LiLiNiO₂, LiFePO₄, LiMnPO₄, LiCoPO₄, LiMn₂O₄, and LiCoO₂, the positive material compositions that include mixed metal oxides of cobalt, mangenese, and nickel such as those described in U.S. Pat. Nos. 6,964,828, 7,078,128 (Lu et al), and U.S. Pat. No. 6,660,432 (Paulsen et al); and nanocomposite positive active materials such as those discussed in U.S. Pat. No. 6,680,145 B2 (Obrovac et al.).

Exemplary materials useful for making negative electrodes of this disclosure include at least one electrochemically inactive elemental metal and at least one electrochemically active elemental metal in the form of an amorphous composition at ambient temperature as is disclosed in U.S. Pat. No. 6,203,944 (Turner et al.). Additional useful active materials are described in U.S. Pat. Appl. Publ. No. 2003/0211390 A1 (Dahn et al,), U.S. Pat. No. 6,2.55,017 B1 (Turner), U.S. Pat. No. 6,436,578 B2 (Turner et al.), and U.S. Pat. No. 6,699,336 B2 (Turner et al.), combinations thereof and other powdered materials that will be familiar to those skilled in the art. Each of the foregoing references is incorporated herein in its entirety.

Electrodes of this invention include graphite. In this application, graphitic carbon or graphite is defined as a form of carbon that has discernable crystalline peaks in its x-ray powder diffraction patterns and has a layered crystalline structure. The interlayer spacing between the graphitic layers (d₀₀₂ spacing) is a direct measure of the crystallinity of graphitic carbon and can be determined by x-ray diffraction. Pristine crystalline graphite has a d₀₀₂ spacing of 33.5 nm. Fully disordered (turbostratic) graphite has a d002 spacing of 34.5 nm. For this disclosure it is preferable that crystalline graphitic carbon be used—with a d₀₀₂ spacing of less than about 34.0 nm, less than 33.6 nm, or even less. Graphites that are suitable for use in this disclosure include SLP30 and SFG-44 graphite powders, both from Timcal Ltd., Bodio, Switzerland, and mesocarbon microbeads (MCMB) from Osaka Gas, Osaka, Japan.

Electrodes of this disclosure include a binder. Exemplary polymer binders include polyolefins such as those prepared from ethylene, propylene, or butylene monomers; fluorinated polyolefins such as those prepared from vinylidene fluoride monomers; perfluorinated polyolefins such as those prepared from hexafluoropropylene monomer; perfluorinated poly(alkyl vinyl ethers); perfluorinated poly(alkoxy vinyl ethers); or combinations thereof. Specific examples of polymer binders include polymers or copolymers of vinylidene fluoride, tetrafluoroethylene, and propylene; and copolymers of vinylidene fluoride and hexafluoropropylene.

In some electrodes, the binders are crosslinked. Crosslinking can improve the mechanical properties of the binders and can improve the contact between the alloy composition and any electrically conductive diluent that can be present. In other anodes, the binder is a polyimide such as the aliphatic or cycloaliphatic polyimides described in U.S. Ser. No. 11/218,448, filed on Sep. 1, 2005. Such, polyimide binders have repeating units of Formula (III)

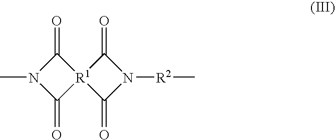

where R¹is aliphatic or cycloaliphatic; and R² is aromatic, aliphatic, or cycloaliphatic.

The aliphatic or cycloaliphatic polyimide binders can be formed, for example, using a condensation reaction between, an aliphatic or cycloaliphatic polyanhydride (e.g., a dianhydride) and an aromatic, aliphatic or cycloaliphatic polyamine (e.g., a diamine or triamine) to form a polyamic acid, followed by chemical or thermal cyclization to form the polyimide. The polyimide binders can also be formed using reaction composites additionally containing aromatic polyanhydrides (e.g., aromatic dianhydrides), or from reaction composites containing copolymers derived from aromatic polyanhydrides (e.g., aromatic dianhydrides) and aliphatic or cycloaliphatic polyanhydrides (e.g., aliphatic or cycloaliphatic dianhydrides). For example, about 10 to about 90 percent of the imide groups in the polyimide can be bonded to aliphatic or cycloaliphatic moieties and about 90 to about 10 percent of the imide groups can be bonded to aromatic moieties. Representative aromatic polyanhydrides are described, for example, in U.S. Pat. No. 5,504,128 (Mizutani et al.).

The binders of this disclosure can contain lithium polyacrylate as disclosed in co-owned application U.S. Ser. No. 11/671,601, filed on Feb. 6, 2007. Lithium polyacrylate can be made from poly(acrylic acid) that is neutralized with lithium hydroxide. In this application, poly(acrylic acid) includes any polymer or copolymer of acrylic acid or methacrylic acid or their derivatives where at least about 50 mole %, at least about 60 mole %, at least about 70 mole %, at least about 80 mole %, or at least about 90 mole % of the copolymer is made using acrylic acid or methacrylic acid. Useful monomers that can be used to form these copolymers include, for example, alkyl esters of acrylic or methacrylic acid that have alkyl groups with 1-12 carbon atoms (branched or unbranched), acrylonitriles, acrylamides, N-alkyl acrylamides, N,N-dialkylacrylamides, hydroxyalkylacrylates, and the like. Of particular interest are polymers or copolymers of acrylic acid or methacrylic acid that are water soluble—specially after neutralization or partial neutralization. Water solubility is typically a function of the molecular weight of the polymer or copolymer and/or the composition. Poly(acrylic acid) is very water soluble and is preferred along with copolymers that contain significant mole fractions of acrylic acid. Poly(methacrylic) acid is less water soluble—particularly at larger molecular weights.

Homopolymers and copolymers of acrylic and methacrylic acid that are useful in this disclosure can have a molecular weight (M_{W}) of greater than about 10,000 grams/mole, greater than about 75,000 grams/mole, or even greater than about 450,000 grams/mole, or even higher. The homopolymers and copolymer that are useful in this disclosure have a molecular weight (M_{W}) of less than about 3,000,000 grams/mole, less than about 500,000 grams/mole, less than about 450,000 grams/mole or even lower. Carboxylic acidic groups on the polymers or copolymers can be neutralized by dissolving the polymers or copolymers in water or another suitable solvent such as tetrahydrofuran, dimethylsulfoxide, N,N-dimethylformamide, or one or more other dipolar aprotic solvents that are miscible with water. The carboxylic acid groups (acrylic acid or methacrylic acid) on the polymers or copolymers can be titrated with an aqueous solution of lithium hydroxide. For example, a solution of 34 wt % poly(acrylic acid) in water can be neutralized by titration with a 20 wt % solution of aqueous lithium hydroxide. Typically enough lithium hydroxide is added to neutralize, 50% or more, 60% or more, 70% or more, 80% or more, 90% or more, or even 100% of the carboxylic acid groups on a molar basis. In some embodiments excess lithium hydroxide is added so that the binder solution can contain greater than 100%, greater than 103%, greater than 107% or even more equivalents of lithium hydroxide on a molar basis based upon the amount of carboxylic acid groups.

Lithium polyacrylate can be blended with other polymeric materials to make a blend of materials. This can be done, for example, to increase the adhesion, to provide enhanced conductivity, to change the thermal properties or to affect other physical properties of the binder. Lithium polyacrylate is non-elastomeric. By non-elastomeric it is meant that the binders do not contain substantial amounts of natural or synthetic rubber. Synthetic rubbers include styrene-butadiene rubbers and latexes of styrene-butadiene rubbers. For example, lithium polyacrylate binders can contain less than 20 wt %, less than 10 wt %, less than 5 wt %, less than 2 wt %, or even less of natural or synthetic rubber.

The disclosed electrodes include composites that include an active material, graphite and a binder. The amount of graphite included in the composites is greater than about 20 vol %, greater than about 25 vol %, greater than about 30 vol %, greater than about 35 vol%, greater than 40 vol %, or even higher amounts of graphite based upon the total volume of the active material and graphite in the composite. The vol % is related to the wt % by the density. As an example, if the composite contains 60.72 wt % of an active material that has a density of 3.8 g/cc. 31.28 wt % of graphite that has a density of 2.26 g/cc and 8 wt % of a binder that has a density of 1.4 g/cc, then 100 grams of the composite would be made up of the following volumes: volume of alloy=60.72 g /(3.8 g/cc)=16.0 cc, volume of graphite=31.28 g/(2.26 g/cc)=13.84 cc and volume of binder=8/(1.4 g/cc)=5.7 cc. The vol % of graphite compared to the total volume of graphite and active material in the composite is then (13.84 cc)/(13.84 cc+16.0 cc)×100%=46.4%.

The composites of the disclosed electrodes also have a porosity of less than about 20%, less than about 15%, less than about 10%, or even less. The porosity can be determined from the actual measured density and the theoretical density at zero porosity of the electrode coatings. The actual measured density is determined by measuring the thickness of the composite after it has been applied to a substrate (usually the current collector) and dried. The theoretical density of a composite of zero porosity can be calculated from the densities of the individual components. For example, if an electrode coating on a current collector substrate is 60.72 wt % of an alloy that has a density of 3.8 g/cc, 31.28 wt % of graphite that has a density of 2.26 g/cc and 8% binder that has a density of 1.4 g/cc, then if the coating had zero porosity, 100 g of this coating would occupy a volume of 60.72 g/(3.8 g/cc)+31.28 g/(2.26 g/cc)+8 g/(1.4 g/cc)=35.53 cc. The theoretical density of this coating with zero porosity is then 100 g 735.53 cc=2.81 g/cc. Then the thickness of the coating on the substrate can be measured by measuring the thickness of the electrode with a micrometer and subtracting away the substrate thickness. From the dimensions of the substrate the actual volume of the coated composite can be calculated. Then the coating weight is measured and a density of the coated composite is calculated. The difference between the theoretical density of a zero porosity composite and the actual density measured is assumed to be caused by pores. The volume of the pores can be calculated and a percent porosity calculated. For the example above, suppose the volume of the electrode coating is measured to be 1.00 cc and that this weighs 2.5 g. Then the volume of the solids in the coating is 2.5 g/(2.81 g/cc)=0.89 cc. The volume of the pores must be 1.00 cc−0.89 cc=0.11 cc. Therefore the percent porosity of this material is 0.11 cc/1.00 cc.×100%=11%.

The porosities of the lithiated coatings can be calculated in the same way as for the unlithiated composites described above except that during lithiation each active component of the electrode coating and the graphite expands a characteristic amount. This volume expansion must be taken into account to calculate the theoretical volume occupied by the solids in a lithiated coating. For example, graphite is known to expand 10% during full lithiation. The percentage of lithiation for alloys in which silicon is the active component can be calculated from the known charge capacity of silicon (3578 mAh/gram) by measuring the charge capacity of the alloy material. In such an alloy, only the electrochemically active silicon expands upon lithiation and if the alloy includes any electrochemically inactive material, this component of the alloy does not expand, therefore the volume expansion of the alloy can be calculated from the percentage of lithiation and the fact that the volume expansion of silicon upon full lithiation is known to be 280%. This allows the theoretical thickness of the lithiated electrode at zero porosity to be calculated. The lithiated electrode percent porosity can be calculated from the difference between the theoretical thickness of the lithiated electrode and the actual measured electrode thickness.

Alternatively the density of the solids of an unlithiated or lithiated electrode can be measured directly by means of a helium pyrometer. The porosity of the electrode can then be calculated by comparing this density to the measured volume and weight of the electrode coating.

Alloys can be made in the form of a thin film or powder, the form depending on the technique chosen to prepare the materials. Suitable methods of preparing the alloy compositions include, but are not limited to, sputtering, chemical vapor deposition, vacuum evaporation, melt spinning, splat cooling, spray atomization, electrochemical deposition, and ball milling. Sputtering is an effective procedure for producing amorphous alloy compositions.

Melt processing is another procedure that can be used to produce amorphous alloy compositions. According to this process, ingots containing the alloy composition can be melted in a radio frequency field and then ejected through a nozzle onto a surface of a rotating wheel (e.g., a copper wheel). Because the surface temperature of the rotating wheel is substantially lower than the temperature of the melt, contact with the surface of the rotating wheel quenches the melt. Rapid quenching minimizes the formation of crystalline material and favors the formation of amorphous materials. Suitable melt processing methods are further described in U.S. Pat. Appl. Publ. Nos. 2007/0020521 A1, 2007/0020522 A1, and 2007/0020528 A1 (all Obrovac et al).

The sputtered or melt processed alloy compositions can be processed further to produce powdered active materials. For example, a ribbon or thin film of the alloy composition can be pulverized to form a powder.

Powdered alloy particles can include a conductive coating. For example, a particle that contains silicon, copper, and silver or a silver alloy can be coated with a layer of conducting material (e.g., with the alloy composition in the particle core and the conductive material in the particle shell). When conductive coatings are employed, they can be formed using techniques such as electroplating, chemical vapor deposition, vacuum evaporation or sputtering. Suitable conductive materials include, for example, carbon, copper, silver, or nickel.

The disclosed electrodes can contain additional components such as will be familiar to those skilled in the art. The electrodes can include an electrically conductive diluent to facilitate electron transfer front the powdered composite to a current collector Electrically conductive diluents include carbon powder (e.g., carbon black for negative electrodes and carbon black, flake graphite and the like for positive electrodes), metal, metal nitrides, metal carbides, metal silicides, and metal borides. Representative electrically conductive carbon diluents include carbon blacks, acetylene black, furnace black, lamp black, carbon fibers and combinations thereof.

The negative electrodes can include an adhesion promoter that promotes adhesion of the powdered composite (active material and graphite) and/or the electrically conductive diluent to the binder. The combination of an adhesion promoter and binder can help the electrode composition better accommodate volume changes that can occur in the powdered composite during repeated lithiation/delithiation cycles. Examples of adhesion promoters include silanes, titanates, and phosphonates as described in U.S. Pat. Appl. Publ. No. 2004/0058240 A1 (Christensen), the disclosure of which is incorporated herein by reference.

To make a negative electrode, the composite of active material and graphite, any selected additional components such as binders, conductive diluents, adhesion promoters, thickening agents for coating viscosity modification such as carboxymethylcellulose, and other additives known by those skilled in the art are mixed in a suitable coating solvent such as water or N-methylpyrrolidinone (NMP) to form a coating dispersion. The dispersion is mixed thoroughly and then applied to a foil current collector by any appropriate dispersion coating technique known to those skilled in the art. The current collectors are typically thin foils of conductive metals such as, for example, copper, stainless steel, or nickel foil. The slurry is coated onto the current collector foil and then allowed to dry in air followed usually by drying in a heated oven, typically at about 80° C. to about 300° C. for about an hour to remove all of the solvent. Then the electrode is pressed or compressed using any of a number of methods. For example the electrode can be compressed by rolling it between two calendar rollers, by placing it under pressure in a static press, or by any other means of applying pressure to a flat surface known to those in the art. Typically pressures of greater than about 100 MPa, greater than about 500 MPa, greater than about 1 GPa, or even higher are used to compress the dried electrode and create low porosity powdered material. A variety of electrolytes can be employed in the disclosed lithium-ion cell. Representative electrolytes contain one or more lithium salts and a charge-carrying medium in the form of a solid, liquid or gel. Exemplary lithium salts include LiPF₆, LiBF₄, LiClO₄, lithium bis(oxalato)borate, LiN(CF₃SO₂)₂, LiN(C₂F₅SO₂)₂, LiAsF₆, LiC(CF₃SO₂)₃and combinations thereof. Exemplary charge-carrying media are stable without freezing or boiling in the electrochemical window and temperature range within which the cell electrodes can operate, are capable of solubilizing sufficient quantities of the lithium salt so that a suitable quantity of charge can be transported from the positive electrode to the negative electrode, and perform well in the chosen lithium-ion cell. Exemplary solid charge carrying media include polymeric media such as polyethylene oxide, polytetrafluoroethylene, polyvinylidene fluoride, fluorine containing copolymers, polyacrylonitrile, combinations thereof and other solid media that will be familiar to those skilled in the art. Exemplary liquid charge-carrying media include ethylene carbonate, propylene carbonate, dimethyl carbonate, diethyl carbonate, ethyl-methyl carbonate, butylene carbonate, vinylene carbonate, fluoroethylene carbonate, fluoropropylene carbonate, γ-butylrolactone, methyl difluoroacetate ethyl difluoroacetate, dimethoxyethane, diglyme (bis(2-methoxyethyl) ether), tetrahydrofuran, dioxolane, combinations thereof and other media that will be familiar to those skilled in the art. Other exemplary liquid charge-carrying media can include additives such as the vinylene carbonates having Structure I where R is H or an alkyl or alkenyl group containing one to four carbon atoms.

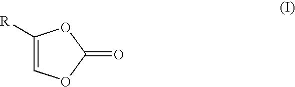

Exemplary materials of Structure (I) that can be useful in this invention include, but are not limited to, vinylene carbonate, methylvinylene carbonate, ethylvinylene carbonate, propylvinylene carbonate, isopropylvinylene carbonate, butylvinylene carbonate, isobuylvinylene carbonate, and the like. Additional additives include ethylene carbonates having Structure II where R is H or an alkyl or alkenyl group containing one to four carbon atoms; X is hydrogen, fluorine or chlorine; and Y is fluorine or chlorine or an alkyl or alkenyl group containing one to four carbon atoms.

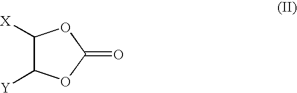

Exemplary materials of Structure (II) that can be useful in this invention include, but are not limited to, fluoroethylene carbonate, chloroethylene carbonate, 1,2-difluoroethylene carbonate, 1-fluoro-2-methylethylene carbonate, 1-chloro-2-methylene carbonate, vinylethylene carbonate and the like. The additives such as those exemplified in Stuctures (I) and (II) can be added to the electrolyte in an amount greater than about 0.5 wt %, greater than about 1.0 wt %, greater than about 5 wt %, greater than about 10 wt %, greater than about 20 wt %, greater than about 30 wt % or even greater of the total weight of the electrolyte.

Exemplary charge carrying media gels include those described in U.S. Pat. No. 6,387,570 (Nakamura et al.), and U.S. Pat. No. 6,780,544 (Noh). The charge carrying media solubilizing power can be improved through addition of a suitable cosolvent. Exemplary cosolvents include aromatic materials compatible with Li-ion cells containing the chosen electrolyte. Representative cosolvents include toluene, sulfolane, dimethoxyethane, combinations thereof and other cosolvents that will be familiar to those skilled in the art. The electrolyte can include other additives that will be familiar to those skilled in the art. For example, the electrolyte can contain a redox chemical shuttle such as those described in U.S. Pat. No. 5,709,968 (Shimizu), U.S. Pat. No. 5,763,119 (Adachi), U.S. Pat. No. 5,536,599 (Alamgir et al.), U.S. Pat. No. 5,858,573 (Abraham et al.), U.S. Pat. No. 5,882,812 (Visco et al), U.S. Pat. No. 6,004,698 (Richardson et al.), U.S. Pat. No. 6,045,952 (Kerr et al,), and U.S. Pat. No. 6,387,571 B1 (Lain et al.), and in U.S. Pat. Appl. Publ. Nos. 2005/0221168 A1, 2005/0221196 A1, 2006/0263696 A1, and 2006/0263697 A1 (all to Dahn et al.).

Electrochemical cells of this disclosure are made by taking at least one each of a positive electrode and a negative electrode as described above and placing them in an electrolyte. Typically, a microporous separator, such as CELGARD 2400 microporous material, available from Hoechst Celanese, Corp., Charlotte, N.C., is used to prevent the contact of the negative electrode directly with the positive electrode.

The electrochemical cells of this disclosure can be used in a variety of devices, including portable computers, tablet displays, personal digital assistants, mobile telephones, motorized devices (e.g., personal or household appliances and vehicles), instruments, illumination devices (e.g., flashlights) and heating devices. One or more electrochemical cells of this disclosure can be combined to provide battery pack. Further details regarding the construction and use of rechargeable lithium-ion cells and battery packs using the disclosed electrodes will be familiar to those skilled in the art.

The disclosure is further illustrated in the following illustrative examples, in which all percentages are by wt % (wt %) unless otherwise indicated.

### EXAMPLES

### Preparatory Example 1

### Si₆₀ Al₁₄FegTi₁Sn₇(MM)₁₀ Alloy Powder

Aluminum, silicon, iron, titanium and tin were obtained in an elemental form having high purity (99.8 wt % or greater) from Alfa Aesar, Ward Hill, Mass. or from Aldrich, Milwaukee, Wis. A mixture of rare earth elements, also known as mischmetal (MM), was obtained from Alfa Aesar with 99.0 wt % minimum rare earth content which contained approximately 50 wt % cerium, 18 wt % neodymium, 6 wt % praseodymium, 22 wt % lanthanum, and 4 wt % other rare earth elements.

The alloy composition, Si₆₀Al₁₄FegTi₁Sn₇(MM)₁₀, was prepared by melting a mixture of 7.89 g aluminum shot, 35.18 g silicon flakes, 9.34 g iron shot, 1.00 g titanium granules, 17.35 g tin shot, and 29.26 g mischmetal in an in an argon-filled arc furnace (commercially available from Advanced Vacuum Systems, Ayer, Mass.) with a copper hearth to produce an ingot. The ingot was cut into strips using a diamond blade wet saw.

The ingots were then further processed by melt spinning. The melt spinning apparatus included a vacuum chamber having a cylindrical quartz glass crucible (16 mm internal diameter and 1.40 mm length) with a 0.35 mm orifice that was positioned above a rotating cooling wheel. The rotating cooling wheel (10 mm thick and 203 mm diameter) was fabricated from a copper alloy (Ni—Si—Cr—Cu C18000 alloy, 0.45 wt % chromium, 2.4 wt % nickel, 0.6 wt % silicon with the balance being copper) that is commercially available from Nonferrous Products, Inc., Franklin, Ind. Prior to processing, the edge surface of the cooling wheel was polished with a rubbing compound (commercially available from 3M, St. Paul, Minn. as IMPERIAL MICROFINISHING) and then wiped with mineral oil to leave a thin film.

After placing a 20 g ingot strip in the crucible, the system was evacuated to 10.6 Pa and then filled with helium gas to 26.6 kPa. The ingot was melted using radio frequency induction. As the temperature reached 1350° C., 53.5 kPa helium pressure was applied to the surface of the molten alloy composition and the alloy composition was extruded through a nozzle onto the spinning (5031 revolutions per minute) cooling wheel. Ribbon strips were formed that had a width of 1 mm and a thickness of 10 micrometers. The ribbon strips were annealed at 200° C. for 2.5 hours under an argon atmosphere in a tube furnace.

### Preparatory Example 2

### Si_{66.5}Fe_{11.2}Ti_{11.2}C_{11.2}Alloy Powder

The alloy composition, Si_{74.8}Fe_{12.6}Ti_{12.6} was prepared by melting silicon lumps (123.31 grams)(Alfa Aesar/99.999%, Ward Hill, Miss.), iron pieces (41.29 grams) (Alfa Aesar/99.97%) and titanium sponge (35.40 grams) (Alfa Aesar/99.7%) in an ARC furnace. The alloy ingot was broken into small chinks and was treated in a hammer mill to produce alloy powder particles of approximately 150 micrometers.

The Si_{66.5}Fe_{11.2}Ti_{11.2}C_{11.2} alloy was made from Si_{74.8}Fe_{12.6}Ti_{12.6} alloy powder (2.872 grams) and graphite (0.128 grams) (available as TIMREX SFG44 from TimCal Ltd, Bodio, Switzerland) by reactive ball milling in a Spex mill (available from Spex Certiprep Group, Metuehen, N.J.) with sixteen tungsten carbide balls (3.2 mm diameter) for one hour in an argon atmosphere.

### Examples 1A and 1B

An electrode with a composition of 60.72 wt % of Si_{66.6}Fe_{11.2}Ti_{11.2}C_{11.2} ball-milled alloy powder (average particle size 1 μm, density=3.76 g/cm³), 31.28 wt % SLP30 graphite powder (density=2.26 g/cm³, d₀₀₂=0.3354-0.3356 nanometers, available from TimCal Ltd. Bodio, Switzerland) and 8 wt % lithium polyacryiate was prepared. A 10 wt % lithium polyacrylate aqueous solution was prepared by mixing together 149.01 g of deionized water, 106.01 g of a 20 wt % lithium hydroxide solution and 100 g of a 34 wt % aqueous solution of poly(acrylic acid) (Aidrich, 250K molecular weight). Then Si₆₆Si_{66.5}Fe_{11.2}Ti_{11.2}C_{11.2} powder (0.8.97 g), SLP30 graphite (0.462 g), lithium polyacrylate solution (1.182 g) and deionized water (0.9 g) were mixed in a 45-milliliter stainless steel vessel containing four 13 micrometer diameter tungsten carbide balls. The mixing was carried out in a planetary micro mill (PULVERISETTE 7 Model; Fritsch, Germany) at a speed setting of 2 for 60 minutes. The resulting mixture was coated onto a 12 micrometer thick electrolytic copper foil using a coating bar with a 100 micrometer gap. The coating was dried under ambient air for 10 minutes and then under reduced pressure at 150° C. for three hours. The dried coating was pressed in a calender roll under 1 GPa pressure. Electrode circles having an area of 2 cm² were cut from the electrode coating. The thickness and the weight of the circles were measured. From these measurements the apparent density of the electrode coating was calculated and the porosity of the coating was determined. The results are listed in Table 1. The electrode coatings, Example 1A and Example 1B, were then placed in electrochemical coin cells versus a lithium metal counter electrode with an electrolyte comprising 1M LiPF₆ in a solvent mixture of 90 wt % ethylene carbonate; dimethyl carbonate (EC: DEC, 1;2 v/v) (Ferro Chemicals (Zachary, La.) and 10 wt % fluoroethylene carbonate (FEC) (Fujian Chuangxin Science and Technology Development, LTP, Fujian, China). The four coin cells were discharged with a constant current to 5 mV at a C/10 rate and held at 5 mV until the discharge current dropped to a C/40rate. Two of these coin cells were then charged to 0.9V at a C/10 rate.

The coin cells were then disassembled in a dry room and the electrodes were rinsed in ethyl methyl carbonate and dried under reduced pressure. The thicknesses of these electrodes were measured and the porosity was calculated. The porosities of the electrodes are listed in Table 1. Before cycling, the porosity of each of the electrode coatings is about 10% of the coating volume. None of the fully lithiated coatings had a porosity that exceeds 30%.

TABLE 1
Porosity of Electrode Coatings

| | | | | | Calculated | | |
|---|---|---|---|---|---|---|---|
| | Measured | Measured | | | Thickness of | Measured | |
| | Electrode | Electrode | Measured | Calculated | Lithiated | Electrode | Calculated |
| | Weight | Thickness | Density of | Porosity | Coating with | Thickness | Porosity |
| | Before | Before | Electrode | Before | Zero | after | after Full |
| | Lithiation | Lithiation | Coating | Lithiation | Porosity | Lithiation | Lithiation |
| | (mg) (1) | (μm) (2) | (g/cc) (3) | (%) | (μm) | (μm) (2) | (%) |
| Example 1A | 27.32 | 31 | 2.50 | 10.6 | 25.7 | 44 | 20 |
| Example 1B | 27.37 | 31 | 2.52 | 10.2 | 25.7 | 44 | 19 |
| Comparative | 28.41 | 36 | 2.21 | 33.4 | 29.8 | 57 | 34 |
| Example 1A | | | | | | | |
| Comparative | 28.19 | 35 | 2.26 | 31.9 | 29.0 | 59 | 38 |
| Example 1B | | | | | | | |

(1) Includes weight of foil current collector of 17.76 mg.
(2) Includes thickness of current collector of 12 μm.
(3) Area of the electrode = 2.0 cm²

### Comparative Examples 1A and 1B

An electrode with a composition of 92 wt % Si_{66.5}Fe_{11.2}Ti_{11.2}C_{11.2} alloy and 8 wt % lithium polyacrylate was made by the same procedure of Example 1 except that 1.84 g of the Si_{66.5}Fe_{11.2}Ti_{11.2}C_{11.2} alloy, 1.6 g of the 10 wt % lithium polyacrylate aqueous solution and 0.9 g of deionized water were used to make the electrode coating mixture. The mixture was coated and dried, the coating was compressed and coin cells were assembled and cycled as described in Example 1. The porosity of the uncycled and cycled electrode coatings are listed in the Table 2. The porosity of each of the Comparative Examples is greater than 20% before they are cycled. The porosity of the electrode coatings which were fully initiated exceeds 30% of the electrode coating volume.

### Examples 2A and 2B

1.188 g of Si₆₀Al₁₄FegTi₁Sn₇MM₁₀ meltspun alloy powder (8 μm particle size) and 0.612 g of MCMB (Osaka Gas, Osaka, Japan) was milled together with 0.040 g of Super P (Timcal Ltd., Bodio, Switzerland) in a planetary ball mill (same as in Examples 1A and 1B) at the setting of 4 for 30 min. Then 0.160 g of polyimide P12555 (HD Microsystems, Parlin, N.J.) was added as a 20% solution together with 2.5 g NMP. The mixture was milled an additional 30 min in the planetary mill. The mixture was coated on a Cu foil and heated in an oven set at 300° C. for 24 hours under argon to provide an electrode with the composition of 59.4 wt % alloy, 30.6 wt % graphite, 2.0 wt % conducting diluent and 8 wt. % hinder. The electrode was calendered to a density of 2.62 g/cc which corresponds to a porosity of 10%. 2325 coin cells were constructed as in Example 1 and discharged against a Li foil to 5 mV vs. Li/Li⁺ for full lithiation of the alloy material. The coin cell was opened, the electrode removed and rinsed with dimethyl carbonate (DMC) and air dried. From the weight and the thickness of the electrode, the density of the electrode was now determined to be 1.44 g/cc. The porosity of the lithiated electrode coating is reported in Table 2

TABLE 2
Porosity of Lithiated Si₆₀Al₁₄Fe₈Ti₁Sn₇MM₁₀/
Graphite Electrode Coatings

| | | | | | Calculated | | |
|---|---|---|---|---|---|---|---|
| | | | | | Thickness | | |
| | | | | | of | | |
| | Measured | Measured | Measured | | Lithiated | Measured | |
| | Electrode | Electrode | Density | Calculated | Coating | Electrode | Calculated |
| | Weight | Thickness | of | Porosity | with | Thickness | Porosity |
| | Before | Before | Electrode | Before | Zero | after | after Full |
| | Lithiation | Lithiation | Coating | Lithiation | Porosity | Lithiation | Lithiation |
| | (mg) (1) | (μm) (2) | (g/cc) (3) | (%) | (μm) | (μm) (2) | (%) |
| Example 2A | 33.04 | 31 | 2.66 | 9.3 | 25.2 | 47 | 26 |
| Example 2B | 32.67 | 31 | 2.56 | 12.7 | 24.2 | 45 | 25 |

(1) Includes weight of foil current collector of 23.21 mg.
(2) Includes thickness of current collector of 12.5 μm.
(3) Electrode area = 2 cm².

### Comparative Examples 2A and 2B

Electrodes of the formulation 92 wt % Si₆₀Al₁₄FegTi₁Sn₇MM₁₀, 2.2 wt % SUPER P, and 5.8 wt % PI 2555, were prepared by the same procedure as Example 1, except that no graphite was included. After calendaring at 1 Gpa in a calendar roll, the density of the electrode was 1.8 g/cc. This corresponds to a porosity of 52%. The electrode was made into 2325 coin cells with a positive electrode of LiCoO₂. After charging to 4.2V, the cell was opened, the anode was removed and rinsed with DMC. After air drying the density was determined to be 0.95 g/cc. The porosity of the lithiated electrode coating is reported in Table 3.

TABLE 3
Porosity of Lithiated Si₆₀Al₁₄Fe₈Ti₁Sn₇MM₁₀ Electrode Coatings

| | | | | | Calculated | | |
|---|---|---|---|---|---|---|---|
| | | | | | Thickness | | |
| | | | | | of | | |
| | Measured | Measured | Measured | | Lithiated | Measured | |
| | Electrode | Electrode | Density | Calculated | Coating | Electrode | Calculated |
| | Weight | Thickness | of | Porosity | with | Thickness | Porosity |
| | Before | Before | Electrode | Before | Zero | after | after Full |
| | Lithiation | Lithiation | Coating | Lithiation | Porosity | Lithiation | Lithiation |
| | (mg) (1) | (μm) (2) | (g/cc) (3) | (%) | (μm) | (μm) (2) | (%) |
| Comparative | 33.00 | 31 | 1.8 | 52.2 | 14.8 | 45 | 51 |
| Example 2A | | | | | | | |
| Comparative | 31.35 | 27 | 1.73 | 54.0 | 10.6 | 37 | 52 |
| Example 2B | | | | | | | |

(1) Includes weight of foil current collector of 27.20 mg.
(2) Includes thickness of current collector of 15 μm.
(3) Electrode area of 2 cm².

### Example 3A, 3B and Comparative Example 3

Electrodes with a composition of 64.7 wt % of Si_{66.5}Fe_{11.2}Ti_{11.2}C_{11.2} ball-milled alloy powder (average particle size 1 μm, density=3.76 g/cm³), 33.3 wt. % TIMREX SLP30 graphite powder (density=2.26 g/cm³, d₀₀₂=0.3354-0.3356 nanometers. TimCal Ltd. Bodio. Switzerland) and 2 wt % lithium polyacryiate were prepared. A 10 wt % lithium polyacryiate aqueous solution was prepared by mixing together 149.01 g of deionized water, 106.01 g of a 20 wt % lithium hydroxide solution and 100 g of a 34 wt % aqueous solution, of poiy(acrylic acid) (Aldrich, 250K molecular weight). The lithium polyacrylate aqueous solution was then diluted to a concentration of 2.5% by the addition of three parts of water to one part of 10% solution. Then Si_{66.5}Fe_{11.2}Ti_{11.2}C_{11.2} powder (1.29 g), SLP30 graphite (0.67 g), 2.5% lithium polyacryiate solution (1.60 g) and deionized water (1.2 g) were mixed in a 45-milliliter stainless steel vessel containing four 13 micrometer diameter tungsten carbide balls. The mixing was carried out in a planetary micro null (PULVERISETTE 7 Model; Fritsch, Germany) at a speed setting of 2 for 60 minutes. The resulting mixture was coated onto a 12 micrometer thick copper foil using a coating bar with a 100 micrometer gap. The coating was dried under ambient air for 30 minutes and then under reduced pressure at 120° C. for two hours. The dried coating was pressed in a calendar roll under 1 GPa pressure. The porosity of the electrode composition was calculated to be 16%, The same electrode composition, was used for Examples 3a, 3b and Comparative Example 3.

Half coin cells were prepared using 2325 button cells. All of the components were dried prior to assembling and the eel! preparations were done in a dry room with a −70° C. dew point. The cells were constructed from the following components and in the following order from the bottom up: Cu foil/Li metal film/Separator/Electrolyte/Separator/Alloy composite electrode/Cu foil. For Comparative Example 3 the electrolyte was 1M LiPF₆ in a 1:2 by volume mixture of ethylene carbonate (EC) and diethylene carbonate (DEC). For Example 3a 10% fluoroethylene carbonate was added to the electrolyte of Comparative Example 3. For Example 3b 10% vinylene carbonate (VC) was added to the electrolyte of Comparative Example 3. 100 microliters of electrolyte solution was used to fill each cell the cells were crimp sealed prior to testing.

The cells of Comparative Example 3 and Examples 3a and 3b were cycled from 0.005 to 0.9 V at the rate of C/4 at room temperature using a Maccor cycler. For each cycle, the cells were first discharged (lithiation of alloy) at a C/4 rate with a trickle current of 10 mA/g at the end of the discharge, and then the cells were allowed to rest for 15 minutes at open circuit. The cells were run through many cycles to determine the extent of capacity fade as a function of the number of cycles completed. Cells that exhibited a lower extent of capacity fade were more desirable. The discharge capacity data for the cells is displayed in Table IV.

TABLE IV
Discharge Capacity Data for Coin Cells of Example 3

| | | Discharge | Irreversible | Capacity Fade - | Total Capacity |
|---|---|---|---|---|---|
| | | Capacity - first | Capacity - first | cycle 2 to 45 | Fade - cycle 1 |
| Example | Electrolyte | cycle (mAh/g) | cycle (%) | (%) | to 45 (%) |
| Comparative 3 | EC: DEC | 761 | 14.12 | 25.00 | 39.12 |
| Example 3a | EC: DEC + | 750 | 14.77 | 0.00 | 14.77 |
| | 10% FEC | | | | |
| Example 3b | EC: DEC + | 740 | 16.65 | 0.00 | 16.65 |
| | 10% VC | | | | |

1. An electrochemical cell comprising:
an electrode comprising a composite comprising:
an active material;
graphite; and
a binder,
wherein the amount of graphite is greater than about 20 volume percent of the total volume of the active material and the graphite, and
wherein the porosity of the composite is less than about 20%; and
an electrolyte comprising at least one of
a) a vinylene carbonate having the structure 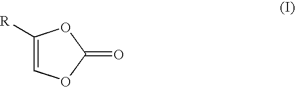
or
b) an ethylene carbonate having the structure 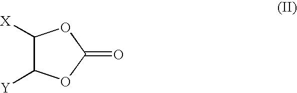
wherein R is H or an alkyl or alkenyl group containing one to four carbon atoms; X is H, F, or Cl; and Y is F or Cl or an alkyl or alkenyl group containing one to four carbon atoms.

2. The electrochemical cell of claim 1 wherein the electrolyte comprises vinylene carbonate.

3. The electrochemical cell of claim 1 wherein the electrolyte comprises an ethylene carbonate having the structure: 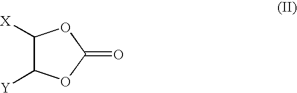
wherein X is H, F, or Cl; and Y is F or Cl or an alkyl or alkenyl group containing one to four carbon atoms.

4. The electrochemical cell of claim 3 wherein X is hydrogen and Y is fluorine.

5. The electrochemical cell of claim 3 wherein X is fluorine and Y is fluorine.

6. The electrochemical cell of claim 3 wherein Y is —CH═CH₂ and X is hydrogen.

7. A battery pack comprising one or more of the electrochemical cells of claim 1.

8. An electrochemical cell comprising;
an electrode comprising:
a composite comprising:
an active material;
graphite; and
a binder,
wherein the amount of graphite in the unlithiated composite is greater than about 20 volume percent of the total volume of the active material and the graphite in the composite,
wherein the composite is lithiated, and
wherein the porosity of the composite is less than about 30%; and
an electrolyte comprising at least one of
a) a vinylene carbonate having the structure 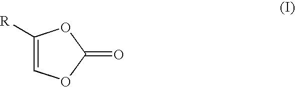
or
b) an ethylene carbonate having the structure 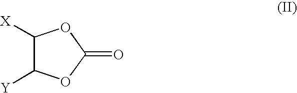
wherein R is h or an alkyl or alkenyl group containing one to four carbon atoms; X is H, F, or Cl; and Y is F or Cl or an alkyl or alkenyl group containing one to four carbon atoms.

9. The electrochemical cell of claim 8 wherein the electrolyte comprises vinylene carbonate.

10. The electrochemical cell of claim 8 wherein the electrolyte comprises an ethylene carbonate having the structure; 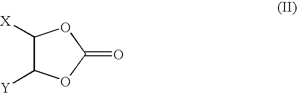
wherein X is H, F, or Cl; and Y is F or Cl or an alkyl or alkenyl group containing one to four carbon atoms.

11. The electrochemical cell of claim 10 wherein X is hydrogen and Y is fluorine.

12. The electrochemical cell of claim 10 wherein X is fluorine and Y is fluorine.

13. The electrochemical cell of claim 10 wherein Y is —CH═CH₂ and X is hydrogen.

14. A battery pack comprising one or more of the electrochemical cells of claim 8.
